(19) United States
(12) Patent Application Publication
(10) Pub. No.: US 2016/0180316 A1
(43) Pub. Date: Jun. 23, 2016

(54) TECHNIQUES TO AUTOMATICALLY PREDICT AND CONFIGURE PAYMENT TRANSACTIONS

(71) Applicant: Facebook, Inc., Menlo Park, CA (US)

(72) Inventors: Xiao Ou Wang, San Francisco, CA (US); Sean Anthony Heywood, Redwood City, CA (US); Stephen Moore Davis, San Francisco, CA (US); Robert Franklin Daniel, Redwood City, CA (US); Akash Gaurav Gupta, Los Altos, CA (US)

(73) Assignee: FACEBOOK, INC., Menlo Park, CA (US)

(21) Appl. No.: 14/573,248

(22) Filed: Dec. 17, 2014

(51) Int. Cl. G06Q 20/22

(52) U.S. Cl. CPC G06Q 20/22; G06Q 50/01

(57) ABSTRACT

Techniques to automatically predict and configure payment transaction are described. In one embodiment, an apparatus may comprise a prediction component operative to receive context information for a user and predict a user interest in a payment transaction based on the context information, a user interface component operative to offer to initiate the payment transaction to the user based on the predicted user interest in the payment transaction and receive a user confirmation of the user interest in the payment transaction, and a payment component operative to initiate the payment transaction in response to the received user confirmation. Other embodiments are described and claimed.

### BACKGROUND

People may develop small debts or join together in paying for something. For example, friends may go out to lunch, one of them may pick up the tab, and the other one may eventually pay the other back. In another example, a group of friends may join together in renting a cabin for a ski trip or purchasing a collective gift for a friend's birthday. When interacting in-person, users may exchange cash or checks to pay or contribute their portion of costs. When interacting online, however, users may find the exchange of money less convenient. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to automatically predict and configure payment transaction. Some embodiments are particularly directed to techniques to automatically predict and configure payment transaction based on social-networking information received from a social-networking service 110. In one embodiment, for example, an apparatus may comprise a prediction component operative to receive context information for a user and predict a user interest in a payment transaction based on the context information, a user interface component operative to offer to initiate the payment transaction to the user based on the predicted user interest in the payment transaction and receive a user confirmation of the user interest in the payment transaction, and a payment component operative to initiate the payment transaction in response to the received user confirmation. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a peer-to-peer payment system.

FIG. 2 illustrates an example of a social graph.

FIG. 3 illustrates an embodiment of a transaction offer.

FIG. 4 illustrates an embodiment of a natural language recognition of a payment proposal.

FIG. 5 illustrates an embodiment of a service request.

FIG. 6A illustrates an embodiment of a user interface for a messaging conversation with a recognized payment proposal.

FIG. 6B illustrates an embodiment of a user interface for configuring a payment request.

FIG. 6C illustrates an embodiment of a user interface for responding to a payment request.

FIG. 6D illustrates an embodiment of user interface display a payment notification.

FIG. 7 illustrates an embodiment of a user interface displaying a news feed.

FIG. 8 illustrates an embodiment of a logic flow for the system of FIG. 1.

FIG. 9 illustrates an embodiment of a centralized system for the system of FIG. 1.

FIG. 10 illustrates an embodiment of a distributed system for the system of FIG. 1.

FIG. 11 illustrates an embodiment of a computing architecture.

FIG. 12 illustrates an embodiment of a communications architecture.

FIG. 13 illustrates an embodiment of a radio device architecture.

### DETAILED DESCRIPTION

Various embodiments are directed to techniques for recognizing opportunities for payment transactions, presenting the opportunities, payment requests, and payment notifications to users, and coordinating payment with groups and service providers. Small payment transactions, that in person would typically be performed using cash, may be inconvenient to perform online, particularly peer-to-peer transactions between individual, personal, non-business entities. It may be inconvenient to procure and run a distinct application or website simply to perform an exchange, and as such it may be convenient to perform exchanges using an existing application used for connecting between friends. It may be difficult to trust the identity of individuals online; therefore, a social-networking service 110 capable of verifying the identity of an individual may reduce the risk of performing a peer-to-peer payment. As a result, the embodiment can improve the convenience and reliability of peer-to-peer payments for users.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

It is worthy to note that “a” and “b” and “c” and similar designators as used herein are intended to be variables representing any positive integer. Thus, for example, if an implementation sets a value for a=5, then a complete set of components 122 illustrated as components 122-1 through 122-a may include components 122-1, 122-2, 122-3, 122-4 and 122-5. The embodiments are not limited in this context.

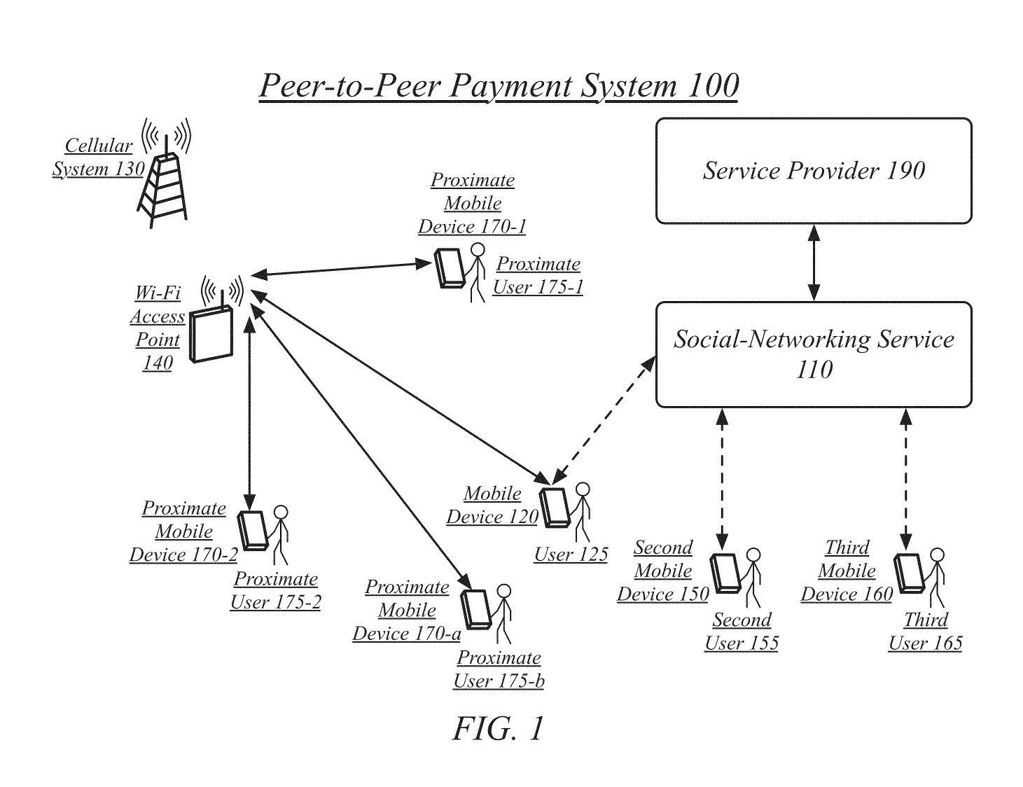

FIG. 1 illustrates a block diagram for a peer-to-peer payment system 100. In one embodiment, the peer-to-peer payment system 100 may comprise a computer-implemented system having software applications comprising one or more components. Although the peer-to-peer payment system 100 shown in FIG. 1 has a limited number of elements in a certain topology, it may be appreciated that the peer-to-peer payment system 100 may include more or less elements in alternate topologies as desired for a given implementation.

A mobile device 120 may communicate with other devices using wireless transmissions to exchange network traffic. Exchanging network traffic, such as may be included in the exchange of payment transactions, may comprise transmitting and receiving network traffic via a network interface controller (NIC). A NIC comprises a hardware component connecting a computer device, such as mobile device 120, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API).

The mobile device 120 may comprise a cellular interface for access to a cellular system 130 and a Wi-Fi interface for access to Wi-Fi access points such as Wi-Fi access point 140. The mobile device 120 may access a cellular system 130 using cellular signals. The cellular system 130 may be a cellular network including data access. The mobile device 120 may access one or more Wi-Fi access points using Wi-Fi signals. Wi-Fi access points may be provided by a plurality of different operators. Some of the Wi-Fi access points may be personal in nature, such as a home Wi-Fi network operated by the user of mobile device 120 based on a domestic Internet connection. Some of the Wi-Fi access points may be provided by business entities providing free, complimentary, or pay Wi-Fi access in the public sphere.

Users may be registered with a social-networking service 110. Users being registered with the social-networking service 110 may correspond to the users being members of the social-networking service 110. Additionally, users may be known to the social-networking service 110 without the users being members of the service, such as through the contacts of users who are members of the social-networking service 110, through information sharing with third-party businesses, through commercial and service outreaching by the social-networking service 110 that doesn't include membership with the social-networking service 110, and other techniques for gaining information about individuals. A user 125 may communicate with the social-networking service 110 using the their mobile device 120.

A user 125 may be friends with other users on the social-networking service 110. Users being friends on a social-networking service 110 may correspond to a registration by the users of a friendship relationship with the social-networking service 110. The user 125 may be friends with a second user 125 and a third user 165, the users respectively using a second mobile device 150 and a third mobile device 160. The second user 155 and third user 165 may also be friends with each other on the social-networking service 110, the third user 165 therefore being a common friend of the first user 125 and the second user 155. The peer-to-peer payment system 100 may leverage knowledge about which users a first user 125 is friends with on the social-networking service 110 in the selection and configuration of payment transactions.

The peer-to-peer payment system 100 may leverage knowledge about proximate users 175 to a user 125. The proximate users 175 may be other members of the social-networking service 110. The proximate users 175 may use proximate mobile devices 170. In some cases, identifying that the proximate mobile devices 170 are proximate to the mobile device 120 of a user 125 may be used to infer that the proximate users 175 are proximate to the user 125. A variety of techniques may be used to identify which mobile devices are proximate to the mobile device 120 for a user 125. For example, if the mobile device 120 and the proximate mobile devices 160 are connected to a common Wi-Fi access point 140, this common connection may indicate that the mobile devices are located in the same vicinity as each other. Additional techniques may be used, including, without limitation, cell site detection, Bluetooth detection, and global positioning system (GPS) detection. In some embodiments, mobile devices 120, 150, 160, 170 may periodically register their location with the social-networking service 110. A user may be able to specify proximate users 175 manually, such as through near field communication (NFC) or taking a picture of an identifier, such as a quick response (QR) code generated by a proximate mobile device 170-1.

Mobile devices 120, 150, 160, 170 may interact with a network server for a service provider 190. The service provider 190 may provide physical services and/or online services, including, without limitation, transportation, communication, entertainment, media, and food and/or beverage services. In some cases, the mobile devices 120, 150, 160, 170 may interact directly with the service provider 190. In other cases, the mobile devices 120, 150, 160, 170 may use the social-networking service 110 as an intermediary in transactions with the service provider 190.

The peer-to-peer payment system 100 may use knowledge generated from interactions in a social-networking service 110. As such, peer-to-peer payment system 100 may include an authorization server (or other suitable component(s)) that allows users to opt in to or opt out of having their actions logged by peer-to-peer payment system 100 or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of peer-to-peer payment system 100 and other elements of a social-networking service 110 through blocking, data hashing, anonymization, or other suitable techniques as appropriate. For example, while interactions between users of a social-networking service 110 and the social-networking service 110 may be used to learn natural language relationships, these interactions may be anonymized prior to or as part of the learning process.

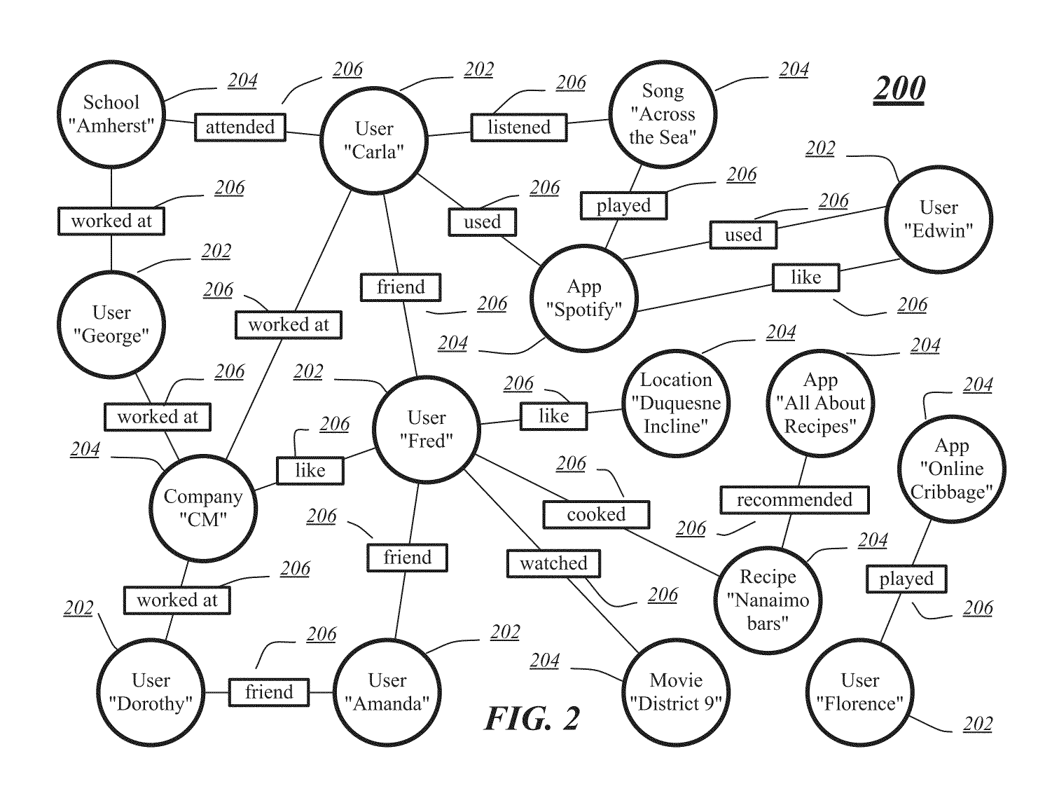

FIG. 2 illustrates an example of a social graph 200. In particular embodiments, a social-networking service 110 may store one or more social graphs 200 in one or more data stores. In particular embodiments, social graph 200 may include multiple nodes, which may include multiple user nodes 202 and multiple concept nodes 204. Social graph 200 may include multiple edges 206 connecting the nodes. In particular embodiments, a social-networking service 110, client system, third-party system, or any other system or device may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of the social-networking service 110. As an example and not by way of limitation, a user may be an individual (human user), an entity (e.g., an enterprise, business, or third-party application), or a group (e.g., of individuals or entities) that interacts or communicates with or over the social-networking service 110. In particular embodiments, when a user registers for an account with the social-networking service 110, the social-networking service 110 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking service 110. In particular embodiments, a user node 202 may be associated with information provided by a user or information gathered by various systems, including the social-networking service 110. As an example and not by way of limitation, a user may provide their name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages. A user node 202 may be associated with a unique user identifier for the user in the social-networking service 110.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking service 110 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking service 110. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to the social-networking service 110. Profile pages may also be hosted on third-party websites associated with a third-party server. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking service 110 a message indicating the user's action. In response to the message, the social-networking service 110 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking service 110 may send a “friend request” to the second user. If the second user confirms the “friend request,” the social-networking service 110 may create an edge 206 connecting the first user's user node 202 to the second user's user node 202 in social graph 200 and store edge 206 as social-graph information in one or more data stores. In the example of FIG. 2, social graph 200 includes an edge 206 indicating a friend relation between user nodes 202 of user “Amanda” and user “Fred” and an edge indicating a friend relation between user nodes 202 of user “Carla” and user “Fred.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, the social-networking service 110 may create a “favorite” edge or a “check in” edge in response to a user's action corresponding to a respective action. As another example and not by way of limitation, a user (user “Carla”) may listen to a particular song (“Across the Sea”) using a particular application (SPOTIFY, which is an online music application). In this case, the social-networking service 110 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking service 110 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Across the Sea”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “Edwin” and concept node 204 for “SPOTIFY”).

In particular embodiments, the social-networking service 110 may create an edge 206 between a user node 202 and a concept node 204 in social graph 200. As an example and not by way of limitation, a user viewing a concept-profile page (such as, for example, by using a web browser or a special-purpose application hosted by the user's client system) may indicate that he or she likes the concept represented by the concept node 204 by clicking or selecting a “Like” icon, which may cause the user's client system to send to the social-networking service 110 a message indicating the user's liking of the concept associated with the concept-profile page. In response to the message, the social-networking service 110 may create an edge 206 between user node 202 associated with the user and concept node 204, as illustrated by “like” edge 206 between the user and concept node 204. In particular embodiments, the social-networking service 110 may store an edge 206 in one or more data stores. In particular embodiments, an edge 206 may be automatically formed by the social-networking service 110 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

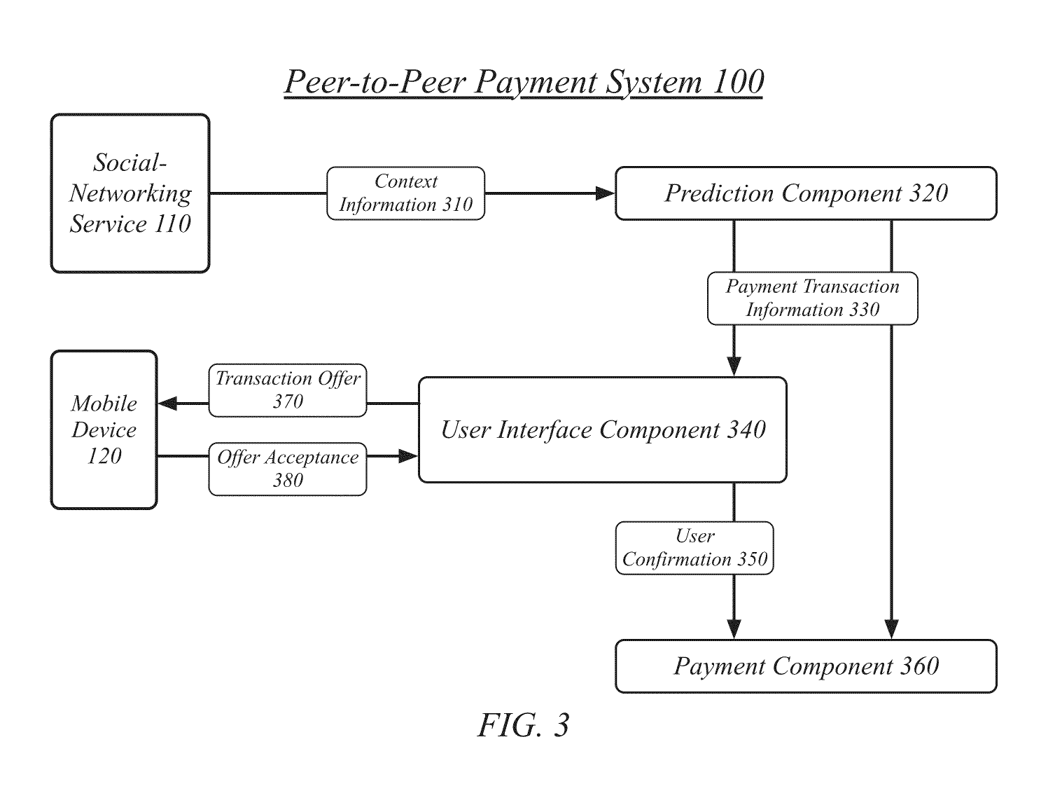

FIG. 3 illustrates an embodiment of a transaction offer 370. The peer-to-peer payment system 100 may predict interest by a user 125 in a payment transaction and offer the transaction to the user 125 on their mobile device 120.

A prediction component 320 may receive context information 310 for a user 125 and predict a user interest in a payment transaction based on the context information 310. Content information 310 may comprise any information known about the user 125 or that relates to the user 125. Where the user 125 is registered with a social-networking service 110, the context information may comprise, at least, social-networking information for the user 125 on the social-networking service 110. The prediction component 320 may generate and pass payment transaction information 330 to a user interface component 340, the payment transaction information 330 defining the proposed payment transaction with details for presentation to a user for acceptance and details for performance with another user, payment system, service provider 190, and/or other related party.

A user interface component 340 may offer to initiate the payment transaction to the user 125 based on the predicted user interest in the payment transaction and receive a user confirmation 350 of the user interest in the payment transaction. Where the user interface component 340 is local to a mobile device 120, the user interface component 340 may engage a user interface of the mobile device 120 through user interface APIs of the mobile device 120 to display a transaction offer 370 and receive an offer acceptance 380 or offer rejection. Where the user interface component 340 is remote from the mobile device 120, such as on a distinct device, the user interface component 340 may communicate with a local application on the mobile device 120 to engage the local application in displaying the transaction offer 370 and receiving an offer acceptance 380 or offer rejection.

A payment component 360 may initiate the payment transaction in response to the received user confirmation 350. The user interface component 340 may notify the payment component 360 that the user has indicated an offer acceptance 380, providing a user confirmation 350 of user interest in the proposed payment transaction. The payment component 360 may receive the payment transaction information 330 from the prediction component 320 or user interface component 340. The payment component 360 may initiate the payment transaction by contacting another user of the social-networking service 110, by contacting a service provider 190, by contacting a payment processor, or according to any other technique for initiating a payment transaction. It will be appreciate that initiating a payment transaction may not result in a complete payment transaction where, for example, another user, a service provider 190, or other involved party declined involvement in the transaction.

The context information 310 may comprise event information for an event in a calendar for the user 125, the payment transaction associated with participation in the event by the user 125. A social-networking service 110 may maintain a calendar for the user 125, the calendar comprising one or more events that the user has created, accepted, or otherwise indicated an association with. Alternatively or additionally, the user 125 may have a separate calendar stored on or accessible to the mobile device 120. In some cases, participation in the event by the user 125 may be associated with a cost. For example, the user may be expected to contribute towards the funds for the rental of a bowling alley for a birthday party for a mutual friend. In some cases this payment may be asked prior to the event and in some cases after the event.

The context information 310 may comprise a location history for the user 125. The prediction component 320 may determine that the location history indicates that the user 125 attended the event and predict the user interest in the payment transaction based at least in part on the indication that the user 125 attended the event. For example, the prediction component 320 may recognize that another user, such as second user 155, is attempting to request or may be interested in requesting that mutual friends of the birthday party recipient who attended the party. In some cases, an event planner may be presented with a user interface element to select that event invitees or event attendees be asked to participate towards the cost of the event. By combining the calendar information and the location history, the prediction component 320 may ease the process of determining appropriate users to ask to pitch in.

The context information may indicate a personal association between a user 125 and a second user 155 in a social-networking service 110 with which they are both registered. The user 125, 155 may be connected by, for example, a friend relationship. Social-networking information for the social-networking service 110 may indicate a sufficiently close friend relationship as to indicate that gift-giving may be appropriate. The prediction component 320 may determine that social-networking information for the second user 155 indicates an upcoming gift-giving occasion for the second user 155, the payment transaction comprising a gift giving, wherein predicting the user interest in the payment transaction is based on the indication of the upcoming gift-giving occasion for the second user 155 and the indication of the personal association between the user 125 and the second user 155. Where multiple users may be appropriate for giving a gift, the users may be offered the opportunity to contribute to a group gift.

The context information 310 may comprise personal relationship information for the user 125 from the social-networking service 110. The prediction component 320 may predict one or more friends of the user 125 in the social-networking service 110 potentially associated with the payment transaction based on the personal relationship information. The user interface component 340 may recommend the one or more friends for inclusion in the payment transaction in response to the prediction. The predicted one or more friends may be presented to the user 125 for selection between in configuring the payment transaction.

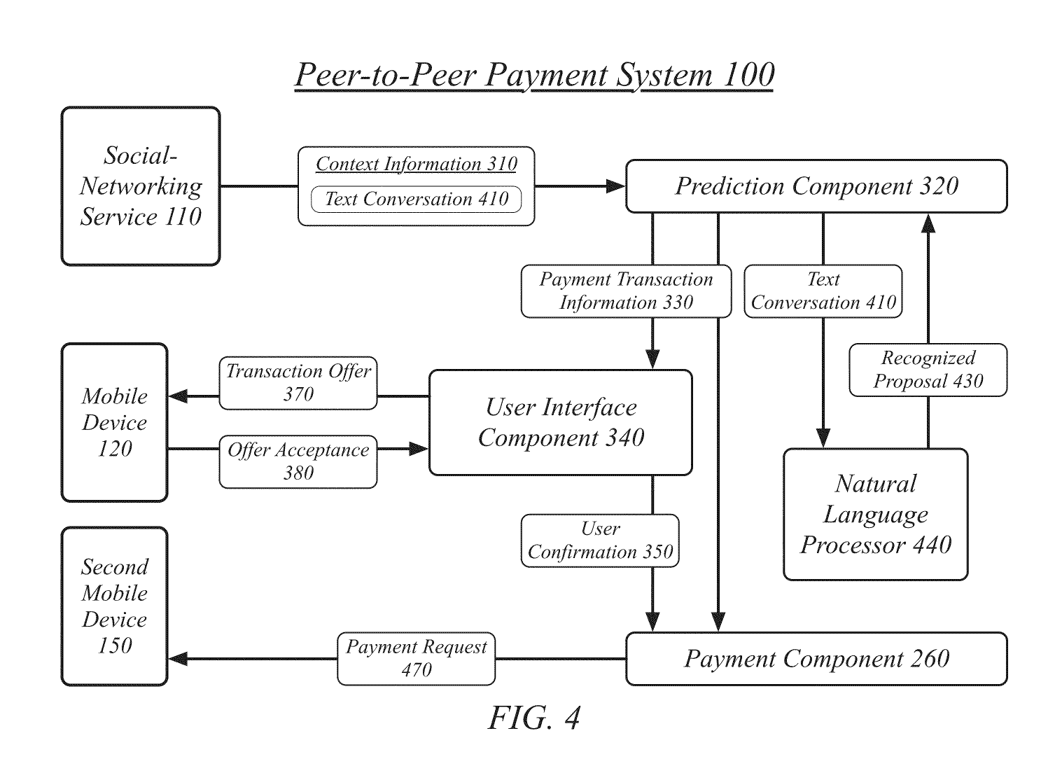

FIG. 4 illustrates an embodiment of a natural language recognition of a payment proposal. In some cases, the opportunity for a payment transaction may arise during a natural language conversation between two or more users. A natural language processor 440 may interpret the natural language conversation and recognize the opportunity, initiating the offering of a transaction to a user 125.

The context information 210 received from the social-networking server 110 may comprise, at least, a text conversation 410 between the user 125 and a second user 155. In some embodiments, the social-networking server 110 may comprise mobile applications executed by the mobile device 120 and the second mobile device 125. As such, the text conversation 410 may be received from one or both of the mobile application on the mobile devices 120, 125. In some embodiments, the prediction component 320 may also execute on one or both of the mobile devices 120, 125 and may be a component of the mobile application, monitoring text conversation performed using the mobile applications and making payment predictions based thereon. Alternatively, the social-networking service 110 may serve as an intermediary in the text conversation 410 and the prediction component 320 may monitor the text messaging system of the social-networking service 110 to detect payment transaction opportunities. The predicted payment transaction may comprise a payment from the user 125 to the second user 155 or may comprise a payment from the second user 155 to the user 125.

Initiating the payment transaction may comprise transmitting a payment request 470 to the second user 155. The payment request 470 may be received by a mobile application on the second mobile device 150. The mobile application may be a same mobile application as used for the text conversation 410 between the user 125 and the second user 155. The payment component 360 may receive an acceptance of the payment request 470 and perform the payment. The user interface component 340 may be notified of an acceptance of the payment request 470 and notify the user 125 via mobile device 120 of the acceptance of the payment request 470 and, once completed, the performance of the payment. Performing the payment may comprise performing a credit card transaction, debit transaction, transferring money between user accounts, or any other technique for performing a payment. Initiating a payment transaction may require an authenticated user permission, such as by requiring the user to enter a passcode, input bioinfometric information (e.g., use a fingerprint reader on the mobile device 120) or any other technique for user authentication.

A natural language processor 440 may perform a natural language processing of the text conversation 410 to determine a natural language text sequence associated with payment by at least one of the user 125 and the second user 155, wherein predicting the user interest in the payment transaction is in response to the determination of the association between the natural language text sequence and payment. For example, the natural language processor 440 may trigger based on payment-associated phrases such as “pay,” “owe,” or “contribute.” The natural language processor 440 may trigger based on a mention of currency, such as through the use of a currency symbol (e.g., a dollar sign). The natural language processor 440 may operate according to any known technique for natural language processing. The natural language processor 440 may perform machine learning to learn and improve the recognition of opportunities to recommend payment transactions.

The natural language processor 440 may return a recognized proposal 430 to the prediction component 320. The recognized proposal 430 may indicate the recognition of an opportunity to recommend a payment transaction and indicate one or more payment configuration details defining elements of the proposed transaction. The payment configuration details may be extracted from the text conversation 410 based on natural language recognition. The payment configuration details may be used to define the payment transaction information 330. Payment configuration details may include, without limitation, one or more payees, one or more payers, and an amount.

The prediction component 320 may determine a confidence level for the determined association between the natural language text sequence and payment. The confidence level may correspond to a degree of confidence that the natural language text sequence actually corresponds to a suggestion that a payment transaction occur. The natural language processor 440 may include a NLP confidence with the recognized proposal 430 indicating a degree of confidence specific to the NLP process. The NLP confidence may be one of one or more factors in determining the overall confidence level.

Additional factors may be used in determining the overall confidence level. Users with an existing relationship, as may be represented in the social-networking service 110, may be believed to be more likely to perform peer-to-peer payments, increasing the confidence level. Users that have performed peer-to-peer payments may be more likely to do so again, increasing the confidence level. The value of the recognized amount may be relevant, with a recognized amount of money being typically associated with the value of peer-to-peer payments increasing the confidence level. For example, friends may be more likely to exchange tens of dollars than millions of dollars or a few cents.

The user interface component 340 may select a notification channel from a plurality of notification channels based on the confidence level. The plurality of notification channels may include a payment opportunity notification attached to the natural language text sequence from the text conversation 410 that prompted the recognition of the recognized proposal 430. The plurality of notification channels may include a banner at the top of a user interface for the mobile device 120, such as the top of the user interface for a messaging application on the mobile device 120. The plurality of notification channels may include inserting a text message in the text conversation 410 between the user 125 and the second user 155, the text message identified as originating from a payment-specific avatar. The plurality of notification channels may include any or all of these channels directed to one or both of the user 125, second user 155, and any other user involved in the text conversation 410. It will be appreciated that these delivery channels are described without limitation and that additional delivery channels may be used.

Each notification channel may be associated with an intrusiveness with more intrusive channels only being used with a higher confidence level and less intrusive channels being used for a lower confidence level. Channels that are visible to the recommended payer may be associated with a higher intrusiveness than channels associated with a recommended payee, due to the greater risk of user frustration with being asked whether they owe money than being asked whether they are owed money.

The peer-to-peer payment system 100 may base a payment prediction on image information received by the peer-to-peer payment system 100, such as through a mobile device 120. In some cases, the prediction component 320 may analyze some or all photos taken by the mobile device 120 to determine whether they correspond to an opportunity to offer a payment transaction. The prediction component 320 may receive image content, determine that the image content corresponds to a bill, determine a payment amount for the payment transaction based on the bill, determine bill context information for the bill, and determine one or more suggested users based on association between the context information and the bill context information. The user interface component 340 may suggest the one or more suggested users for splitting the payment amount for the payment transaction to the user. The payment component 360 may initiate the payment transaction by transmitting a payment request 470 to the one or more suggested users. It will be appreciated that a bill may be received according to other techniques, such as being pushed to the mobile device 120 via the social-networking service 110 from a service provider 190.

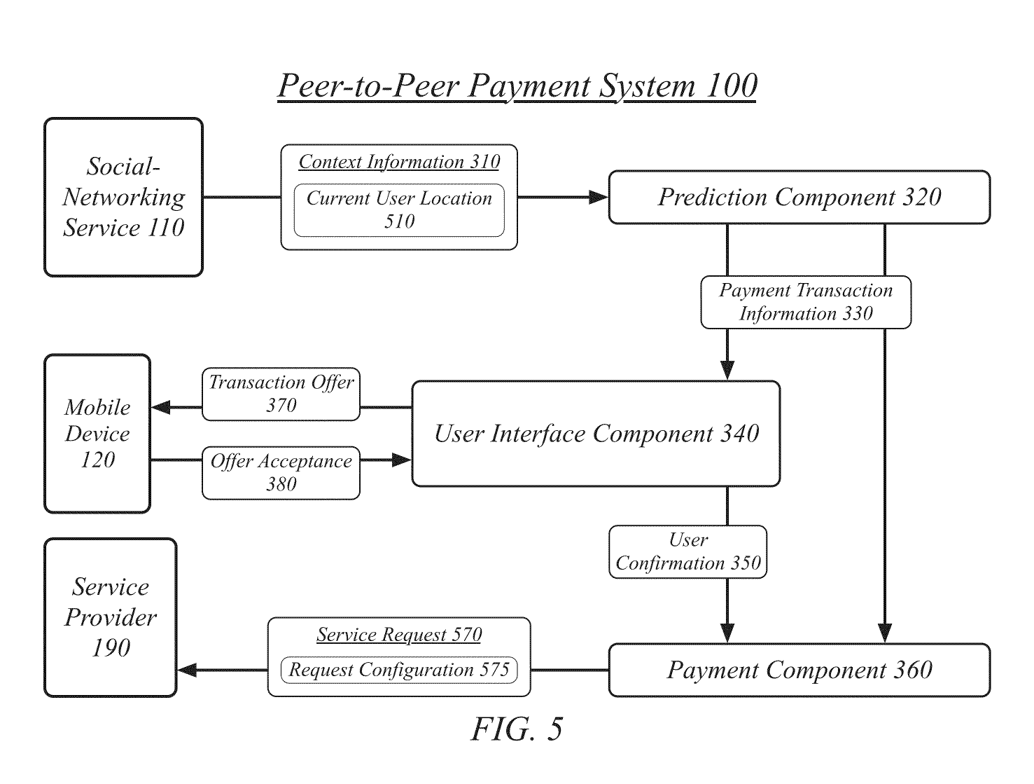

FIG. 5 illustrates an embodiment of a service request 570. In some cases, a payment transaction between two or more users may include the performance and coordination of a service with a third-party service provider 190.

The context information 310 may comprise a current user location 510 for the user 125. The current use location 510 may correspond to a determined location for the mobile device 125, the location for the mobile device 125 used as a proxy to infer the location of the user 125. The current user location 510 may be received in response to a request for the current user location 510 based on an interest in a location-based service, or may be received as part of the general operation of the social-networking service 110, such as where the social-networking service 110 tracks, with user permission, the location of its users in order to improve their utility with the social-networking service 110.

The payment transaction may be associated with a location-based service. A location-based service may comprise one of, without limitation, a transportation service, a food or drink service, and an entertainment service. The prediction component 320 may determine a service provider 190 and a request configuration 575 for the service provider 190. At least one of the determination of the service provider 190 and the determination of the request configuration 575 may be based on the current user location 510 of the mobile device 120.

A current user location 510 may be used in selecting a service provider 190 that services a geographic area including the current user location 510. A service provider 190 may be associated with one or more geographic areas describing areas that it serves. For example, a taxi company may be associated with area to which it will dispatch cabs. A current user location 510 may be used in selecting a service provider 190 with a geographic location geographically proximate to the current user location 510. A service provider 190 may be associated with one or more locations at which it provides service. For example, a coffee chain may have a plurality of branches each associated with a particular geographic location, with the prediction component 320 operative to select the service provider 190 on the basis of it having a branch with a geographically proximate location and select the geographically proximate branch as part of configuring a request configuration 575 for the service request 570 to the service provider 190.

A current user location 510 may be used in generating a request configuration 575 for the service request 570. The request configuration 575 may include a field for specifying a location, with the current user location 510 being entered in that field. For example, a request configuration 575 for a taxi company may include a field for entering a pickup location, which the prediction component 320 may automatically configure as the current user location 510. Similarly, the request configuration 575 may include a field for specifying a branch of division of the service provider 190, with the current user location 510 being used to determine a geographically proximate branch or division to enter in that field. For example, a restaurant chain may require that a specific chain location be specified in requesting a reservation, with the prediction component 320 selecting the chain location as the chain location closest to the current user location 510.

The payment component 360 may transmit the service request 570 to the service provider 190 in response to the received user confirmation 350 of the user interest in the payment transaction, the service request 570 comprising the request configuration 575. The user interface component 340 may display the details of the service request 570 and request configuration 575 to the user for their approval as part of the transaction offer 370. The user interface component 340 may handle the details of the service request 570 and request configuration 575 as temporary assignments until approved by the user 125 and allow the user 125 to change any of those details, with the payment component 360 initiating the payment transaction based on any changes made by the user 125.

A user 125 may benefit from being recommended a second user 155 to share a service. For example, two or more users may share a cab provided by a taxi service. Where a first user 125 and second user 155 are registered with a social networking service 110 and the payment transaction is associated with a service provider 190, the prediction component 320 may determine a social graph relationship between the first user 125 and the second user 155. The user interface component 340 may display a recommendation to share a service provided by the service provider 190 with the second user 155 to the first user 125, the recommendation displayed to the first user 125 in association with notification of the determined social graph relationship. For instance, the first user 125 may be told that the second user 155 is their direct friend, a friend-of-a-friend, a friend of a work colleague, or any other type of social graph relationship.

The recommendation displayed to the first user 125 may include a reputation score for the second user 155. The reputation score may reflect a predicted reliability of the second user 155 based on a reputation that they have developed with users of the social-networking service 110. The social-networking service 110 may therefore act to improve the comfort of a user 125 in sharing a service with a user, such as a friend-of-a-friend that they may not personally. The reputation score may reflect explicit signals as to the reputation of the second user 155, such as a reputation rating or other explicit registration of a reaction by a third user 165 that has shared a service with the second user 155. The reputation score may reflect implicit signals as to the reputation of the second user 155, such as their relationship with other users, their behavior on the social-networking service 110, their behavior on other online services into which the social-networking service 110 as visibility, or any other information available to the social-networking service 110 that may reflect a user's reliability without being an explicit scoring of it with the social-networking service 110.

In some cases, a service provider 190 may allow the social-networking service 110 to extend their services to non-registered users via an association with a registered user. Alternatively, in some cases, the social-networking service 110 may be able to extend services from a service provider 190 even without an explicit allowance, such as one user 125 having a cab pick up a second user 155 on the way to a third location. As such, the prediction component 320 may determine that the user 125 is registered with the service provider 190, determine that a second user 155 is not registered with the service provider 190, and offer use of a service provided by the service provider 190 to the second user 155 by sharing use of the service with the user 125.

Users may benefit from being automatically offered the option of splitting a bill with other users. Users may be predicted as being interested in the splitting of some bills, such as, for example, restaurant service, based on their physical proximity. The context information 310 may comprise a determination of physical proximity to one or more suggested users. The suggested users may be selected as other users with which the user 125 has a friend relationship in the social-networking service that are also proximate to the current user location 510. These proximate users 175 may be selected according to the proximity of their proximate mobile devices 170.

The user interface component 340 may suggest the one or more suggested users for splitting payment of the payment transaction to the user 125. The user interface component 340 may receive a user selection of one or more selected users of the one or more suggested users. In response to the user selection, the payment component 360 may transmit a payment request 470 to the one or more selected users.

Users may be interested in engaging in peer-to-peer commerce. For example, one user may sell another user an item. However, it can be difficult to know whether another person online can be trusted in such a transaction. The social information accessible to the social-networking service 110 may therefore be used to determine a third-party that can mediate any disputes that may arise, with the third-party more likely to be trusted by each of the participants in the transaction than they trust each other. The prediction component 320 may determine a third user 165 of the social-networking service 110 based on relationship information for the user 125 and the second user 155. For example, the third user 165 may be selected as a person with at least a first (friend), second (friend-of-a-friend), or third (friend-of-a-friend-of-a-friend) degree relationship on the social-networking service 110 with both of the users. The user interface component 240 may recommend the third user 1165 as a mediator of the payment transaction to the user 125 and the second user 155. The payment component 360 may empower the mediator to release a payment from escrow to the payee in the transaction, refund an escrowed payment to the payer in the transaction, or otherwise manage the transaction on behalf of the user 125 and second user 155. The mediator may be charged with seeking an equitable solution to any disputes that may arise in the transaction.

A mediator may also be used for interactions other than sales. For example, a first user 125 may make a prediction as to a future event with which the second user 155 disagrees. The first user 125 and second user 155 may agree to evaluate the prediction after a set amount of time has passed. The mediating third user 165 may be agreed to, based on the recommendation by the peer-to-peer payment system 100, as a judge of whether the prediction came true. The decision of the judge may be posted to the news feeds of the first user 125, the second user 155, and other related users in the social-networking service 110.

Similarly, a user 125 may be benefited by knowing whether the second user 155 is honestly presenting themselves prior to engaging in peer-to-peer commerce with the second user 155. The second user 155 may be associated with identity information for the second user 155 in the social-networking service, the identity information shared with the user 125. The user interface component 340 may display a realness score for the second user 155 to the user 125, the realness score representing a confidence in the accuracy of the identity information for the second user 125 in the social-networking service 110. The realness score may be retrieved from the social-networking service 110.

The peer-to-peer payment system 100 may maintain a transaction history for each user. The peer-to-peer payment system 100 may have performed a previous payment transaction for the user 125, the previous payment transaction associated with previous context information, the previous payment transaction and its associated previous content information retrieved from the transaction history. The prediction component 320 may determine a correspondence between the context information and the previous context information and predict the user interest in the payment transaction based on the correspondence between the context information 210 and the previous context information. The prediction component 320 may determine, for instance, that a user habitually requests the peer-to-peer payment system 100 to split a restaurant bill at weekday lunchtimes when geographically located in a restaurant. Where the user is offered the opportunity to split a bill prematurely, the user may select a reminder-request user interface element to request that they be reminded later that they're interested in requesting that a bill be split. A default option for splitting a bill might comprise an even split of a user-specified amount, with the option to perform more complex per-person splits also being available.

Similarly, the context information 310 may comprise a current user location 510 and a user activity history, the user activity history generated by a social-networking service 110. The prediction component 320 may determine a service provider 190 in proximity to the current user location 510 and providing a service represented in the user activity history, wherein the predicted user interest comprises reception of the service by the user 125 from the service provider 190, wherein offering to initiate the payment transaction comprises recommending the service provider 190 to the user 125. For example, a user that regularly eats lunch at a particular time may be recommended a nearby restaurant when their lunch time approaches. The prediction component 190 may further only recommend the service provider 190 where a calendar for the user 125, as may be stored on the social-networking service 110 or accessible to the mobile device 120, indicates that the user 125 doesn't have anything scheduled at that time. The prediction component 320 may determine a time of day associated with the service represented in the user activity history and recommend the service provider 190 to the user 125 in response to a determination that the user 125 is unscheduled at the time of day in a current day in a calendar for the user 125.

Information about multiple user debts could be used to settle balances. The prediction component 320 may determine that a cycle of debts is owed: a first user owes a second user, who owns a third user, and so on until the first user is themselves owed. The user interface component 340 may offer to deduct the amount of the smallest debt owed from each debt if all members of the cycle agree.

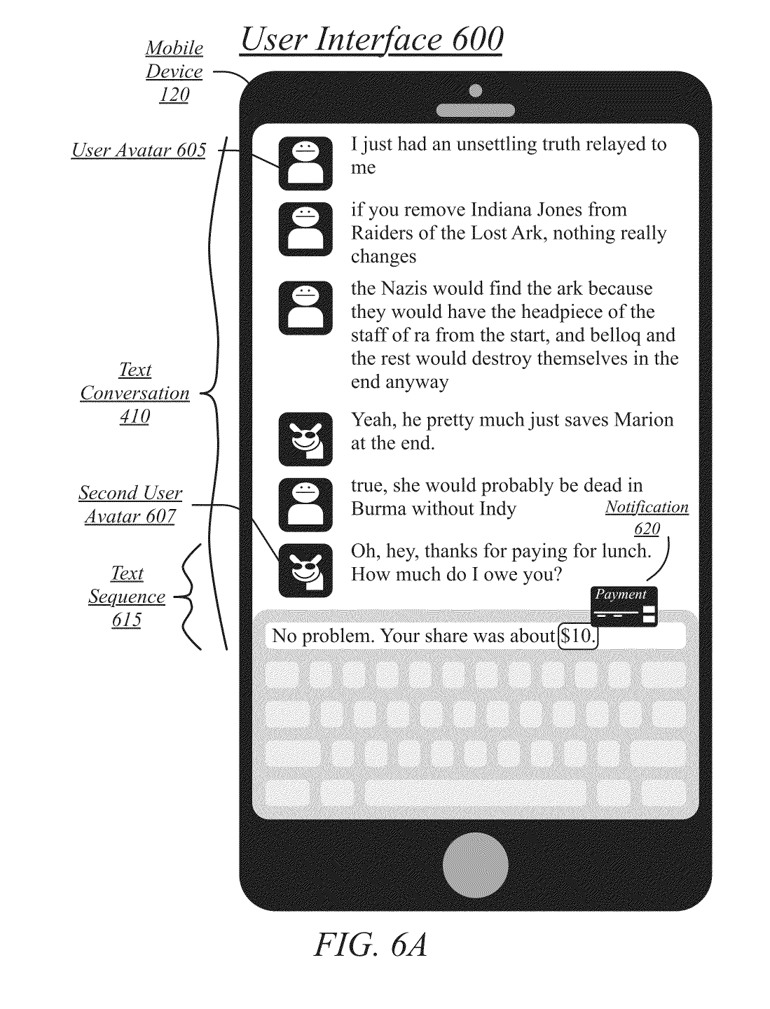

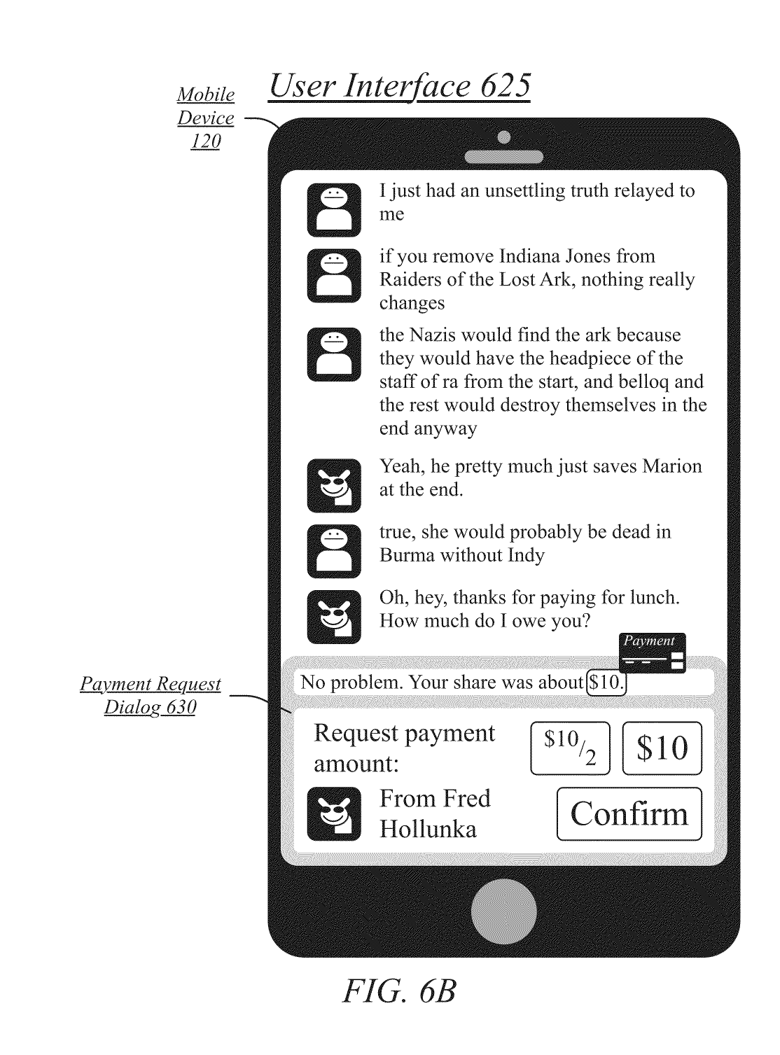

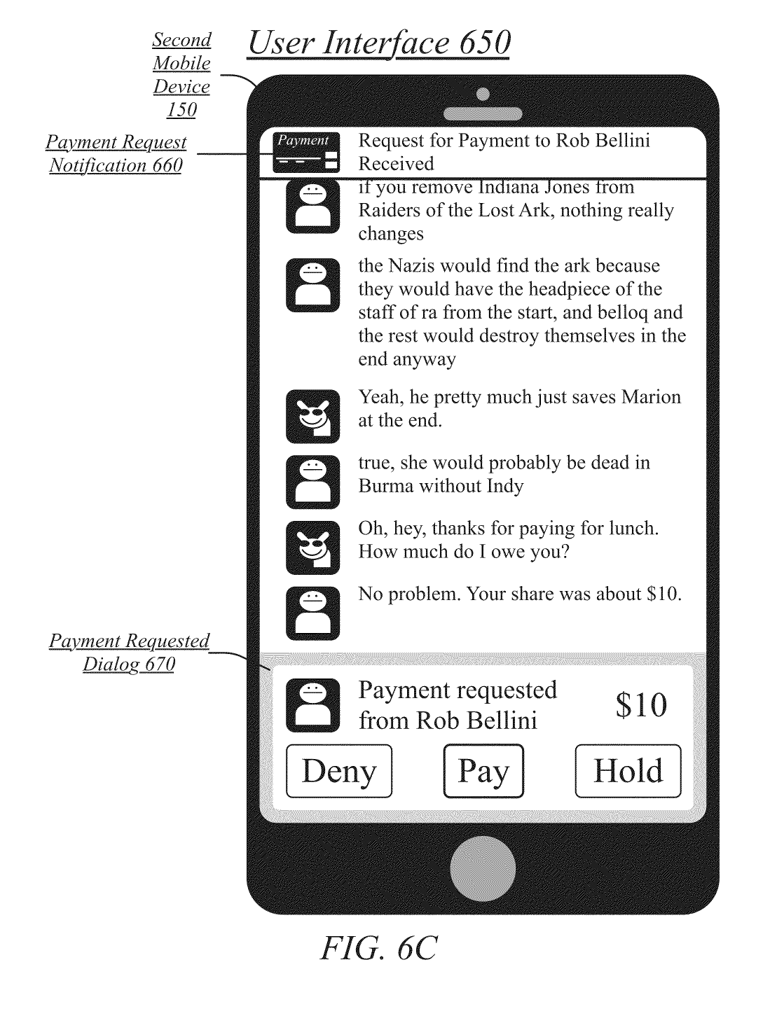

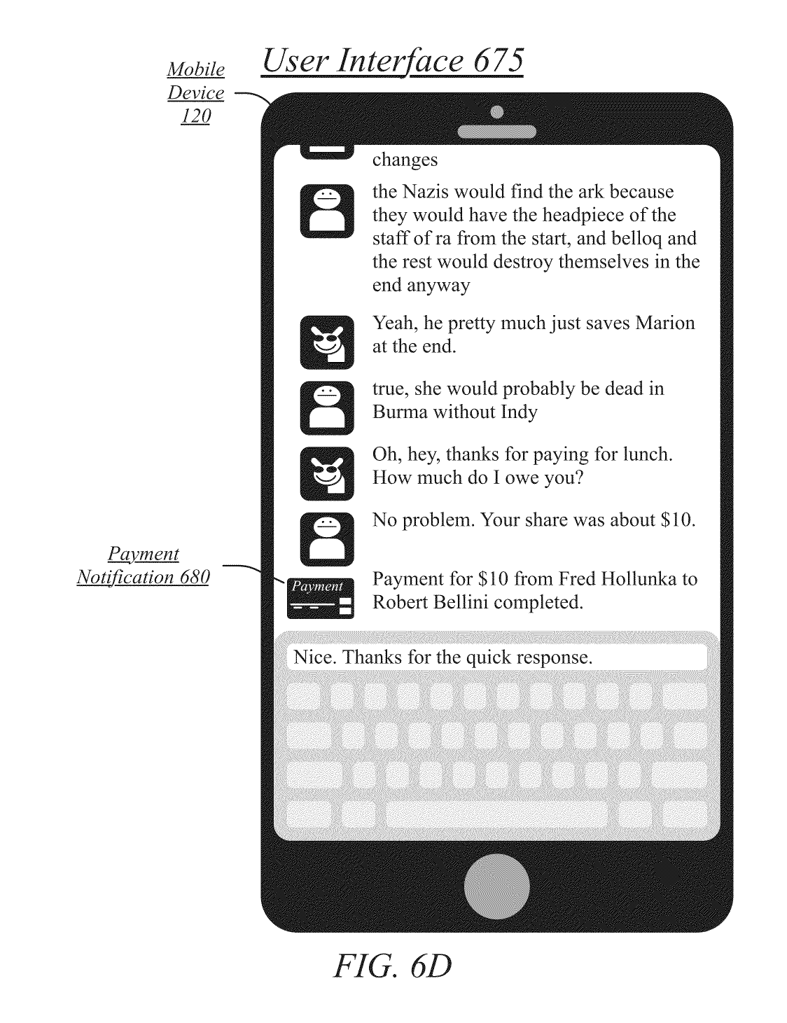

FIG. 6A illustrates an embodiment of a user interface 600 for a messaging conversation with a recognized payment proposal. The mobile device 120 for a first user 125 may display a user interface 600 for a messaging application for a social-networking service 110.

User 125 may be associated with a user avatar 605, the user avatar 605 associated with the user 125 in activities on the social-networking service 110, including messaging services. Second user 155 may be associated with a second user avatar 607, the second user avatar 607 associated with the second user 155 in activities on the social-networking service 110, including messaging services.

A text conversation 410 between the first user 125 and the second user 155 may be displayed in a messaging interface of the user interface 600. It will be appreciated that a longer text conversation 410 may be displayed in a truncated form due to limitation on the screen real estate of the mobile device 120. The mobile device 120 may display a payment transaction notification 620 in association with the text conversation 410 in the messaging interface.

As illustrated in FIG. 6A, the notification 620 may be displayed in conjunction with a text sequence 615 prompting the notification 620. In illustrated, the text conversation 410 includes the exchange “Oh, hey, thanks for paying for lunch. How much do I owe you?” and a response being entered “No problem. Your share was about $10.” The recognition of this as a payment transaction opportunity may be based on, at least, the words “paying,” “owe,” “share,” and the use of a dollar amount ($10) in a range recognized—such as by machine learning—as being commonly used in interpersonal financial transactions. As illustrated, in some embodiments, the text sequence 615 being analyzed may include prospective text sequence still in the process of being entered by a user 125.

The notification 620 may be selectable by the user 125, such as by tapping on the icon for notification 620. In the illustrated example of FIG. 6A, the notification 620 highlights the recognized dollar amount and includes a symbol indicating that the highlighting is associated with a proposed payment transaction notification 620. The mobile device 120 may receive a user selection to view the payment transaction notification 620.

FIG. 6B illustrates an embodiment of a user interface 625 for configuring a payment request. The mobile device 120 may receive a user selection to view a payment transaction notification 620. The mobile device 120 may display an offer to initiate the payment transaction to the user 125 in the messaging interface in response to the received user selection to view the payment transaction notification.

The payment request dialog 630 may empower the second user 155 to select an amount for the payment transaction. As illustrated, the payment request dialog 630 may propose the amount recognized from the text conversation 410 as a selectable button reading that amount ($10). The payment request dialog 630 may also propose that the recognized amount be shared between the two users 125, 155 as a selectable button reading the amount to be shared and the number of people sharing it ($10/2). The payment request dialog 630 may empower the user 125 to customize the amount to any desired value.

The payment request dialog 630 may display the identity of the second user 155 from which the payment is being requested. The payment request dialog 630 may display the identity in association with the second user avatar 670 for the second user 155. In some embodiments, selecting a portion of the payment request dialog 630 indicating the second user 155 from which payment is being requested may result in a dialog allowing a different or additional users to be selected.

The payment request dialog 630 may include a confirmation button empowering the user 125 to initiate the payment request 470, such as by associating the payment request 470 with the text being entered.

FIG. 6C illustrates an embodiment of a user interface 650 for responding to a payment request. With the first user 125 having elected to initiate the payment request 470, the payment component 360 may perform a payment request 470 with the second mobile device 150 belonging to and associated with the second user 155. The payment component 360 may request that the second mobile device 150 display a payment request notification 660, which may comprise, for example, a banner notification. Notification requests on the second mobile device 150 may be transmitted to a mobile application executed by the second mobile device 150, the mobile application associated with the social-networking service 110.

Upon the second user 155 selecting the payment request notification 660, the second mobile device 150 may display a payment requested dialog 670. The payment requested dialog 670 may display the requesting user 125, the amount request, and a user avatar 605 for the requesting user 125. The payment requested dialog 670 may empower the second user 155 to agree to the payment request 470, deny the payment request 470, or put the decision to respond to the payment request 470 on hold. In some cases, the payment component 360 may instruct the mobile application on the mobile device 150 to display the payment requested dialog 670 immediately, without a user selection of a payment request notification 660.

FIG. 6D illustrates an embodiment of user interface 675 display a payment notification. With the second user 155 having agreed to the payment transaction, the payment component 360 will have performed the payment transaction, debiting money from the second user 155 and crediting money to the user 125. The messaging application for the social-networking service 110 may display a payment notification 680 to one or both of the users 125, 155 as to the successful payment transaction. In some embodiments, notifying the user 125 and the second user 155 of the payment transaction may be performed by inserting a text message in the text conversation 410 between the user 125 and the second user 155, the text message identified as originating from a payment-specific avatar.

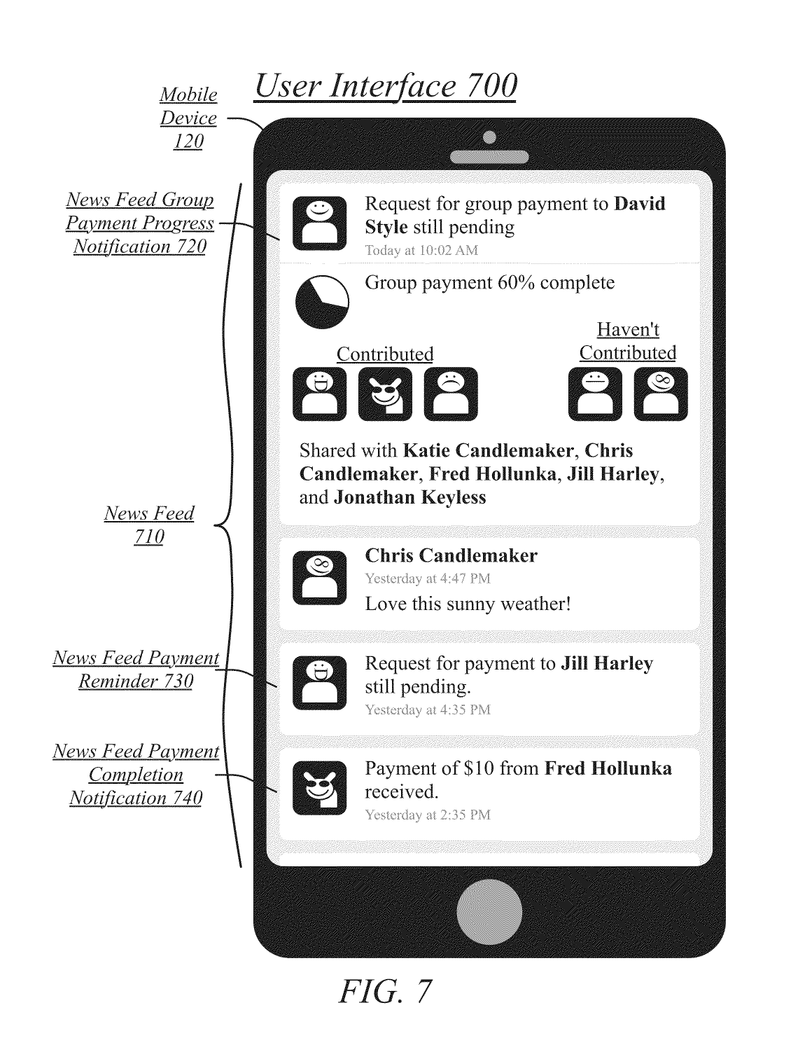

FIG. 7 illustrates an embodiment of a user interface 700 displaying a news feed 710. The news feed 710 may comprise a compendium of items of personal news related to the user 125. One or more of these items may be displayed in relation to activities of the peer-to-peer payment system 100.

The payment transaction initiated by the payment component 360 may be for payment by the user 125 to a second user 155, both the first user 125 and second user 155 registered with the social-networking service 110 also providing the news feed 710 to the user 125. Where the user 125 has not either made payment or rejected the request, the peer-to-peer payment system 100 may remind the user 125 using the news 710 of the pending payment request. The user interface component 340 may insert a news feed payment reminder 730 for the payment into a news feed 710 of the social-networking service for the user 125. The news feed payment reminder 730 may display a name for the second user 155, a second user avatar 607 for the user, and a date and time at which the payment request was generated.

The payment transaction initiated by the payment component 360 may be for payment by a second user 155 to the user 125. If the second user 155 has made payment, the peer-to-peer payment system 100 may notify the user that payment was made using the news feed 710. The user interface component 340 may insert a news feed payment completion notification 740 for the payment transaction into the news feed 710 of the social-networking service 110 for the user 125. The news feed payment completion notification 740 may display a name for the second user 155, a second user avatar 607 for the user, and a date and time at which the payment transaction was completed.

The payment transaction initiated by the payment component 360 may be for a collective payment by a group of users. The various members of the group may be interested in seeing the progress of the payment. As such, the user interface component 340 may insert a news feed group payment progress notification 720 for the payment transaction into a news feed 710 of the social-networking service 110 for at least one user 125 of the group of users. The news feed group payment progress notification 720 may display a name for one or more users of the group of users, user avatars for one or more users of the group of users, a group payment progress indicator, an indicator of which users have contributed, an indicator of which users have not contributed, a date and time at which the payment transaction was requested, a date and time at which the payment transaction was completed, and/or a date and time of the most recent payment as part of the payment transaction.

Further, the social-networking service 110 may be able to use the visibility provided by the information it provides to its users to pressure users into either paying a request or explicitly indicating that they are declining to pay. The user interface component 340 may determine a delinquent user of the group of users based on the delinquent user having not performed a portion of the collective payment assigned to the delinquent user and insert a payment reminder for the payment transaction into a news feed of the social-networking service for the delinquent user, the payment reminder comprising a notification of group participation in the payment transaction. The notification of group participation may further indicate that other users of the group of users are also recipients of the notification of group participation.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

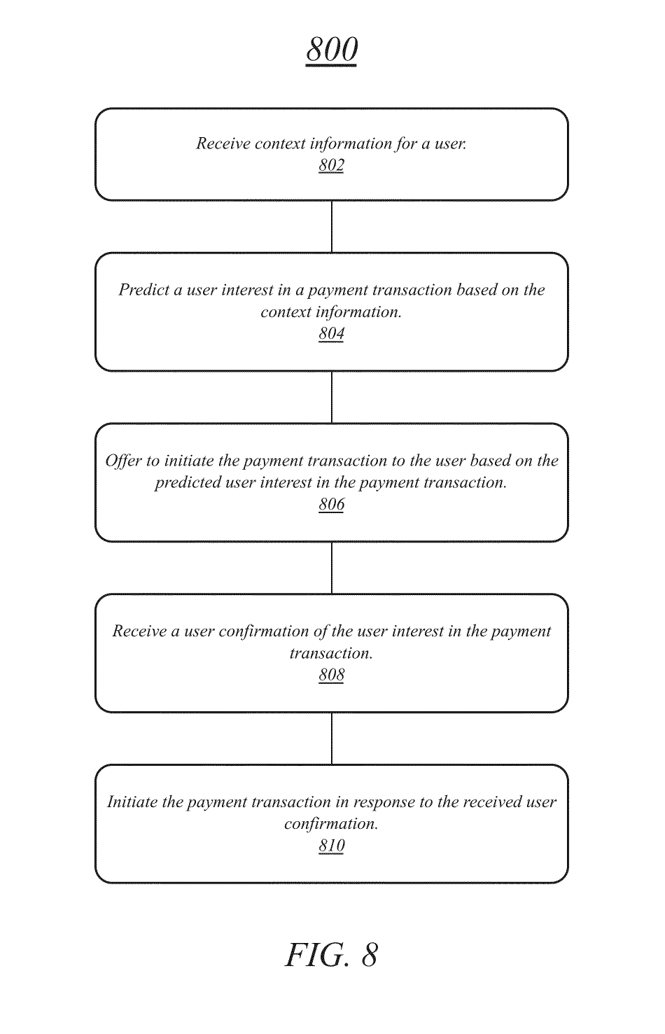

FIG. 8 illustrates one embodiment of a logic flow 800. The logic flow 800 may be representative of some or all of the operations executed by one or more embodiments described herein.

In the illustrated embodiment shown in FIG. 8, the logic flow 800 may receive context information 310 for a user 125 at block 802.

The logic flow 800 may predict a user interest in a payment transaction based on the context information 310 at block 804.

The logic flow 800 may offer to initiate the payment transaction to the user 125 based on the predicted user interest in the payment transaction at block 806.

The logic flow 800 may receive a user confirmation 350 of the user interest in the payment transaction at block 808.

The logic flow 800 may initiate the payment transaction in response to the received user confirmation 350 at block 810.

The embodiments are not limited to this example.

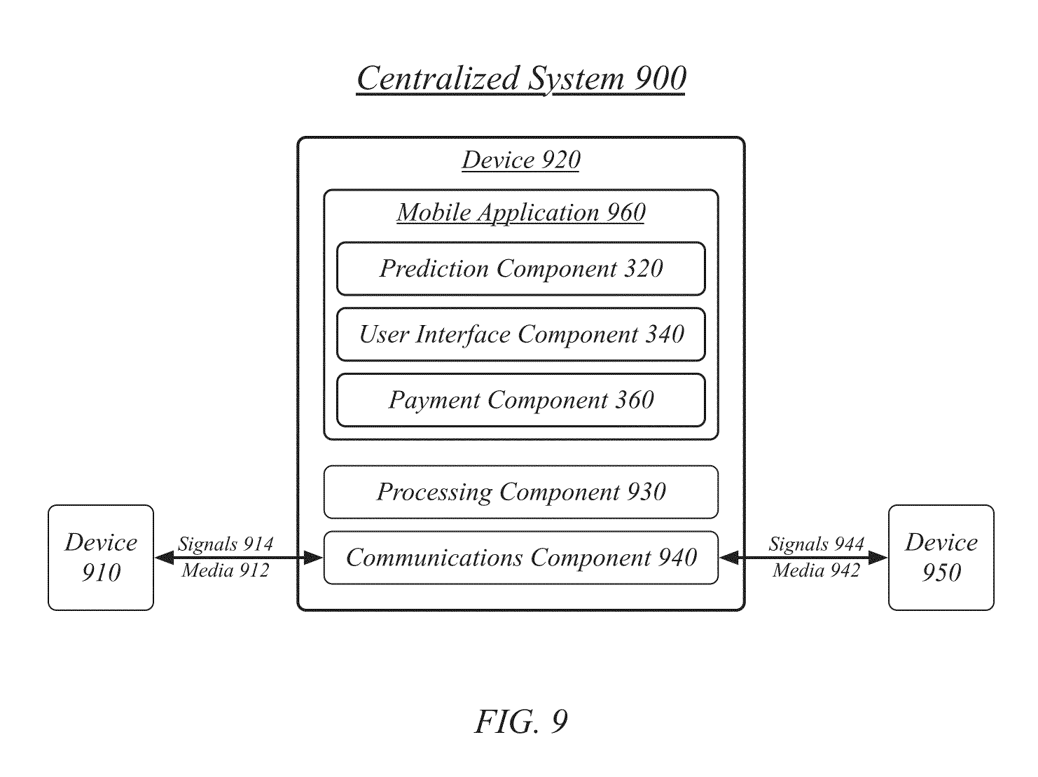

FIG. 9 illustrates a block diagram of a centralized system 900. The centralized system 900 may implement some or all of the structure and/or operations for the peer-to-peer payment system 100 in a single computing entity, such as entirely within a single device 920.

The device 920 may comprise any electronic device capable of receiving, processing, and sending information for the peer-to-peer payment system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 920 may execute processing operations or logic for the peer-to-peer payment system 100 using a processing component 930. The processing component 930 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 920 may execute communications operations or logic for the peer-to-peer payment system 100 using communications component 940. The communications component 940 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 940 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 912, 942 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 920 may communicate with other devices 910, 950 over a communications media 912, 942, respectively, using communications signals 914, 944, respectively, via the communications component 940. The devices 910, 950 may be internal or external to the device 920 as desired for a given implementation. The device 920 may correspond to a mobile device 120, the mobile device 120 executing a mobile application 960. The mobile application 960 may be an application for use of a social-networking service 110. The mobile application 960 may comprise the prediction component 320, user interface component 340, and the payment component 360 for the peer-to-peer payment system 100. One or more of devices 910, 950 may correspond to server devices for the social-networking service. One or more of devices 910, 950 may correspond to other mobile devices interacting with the device 920.

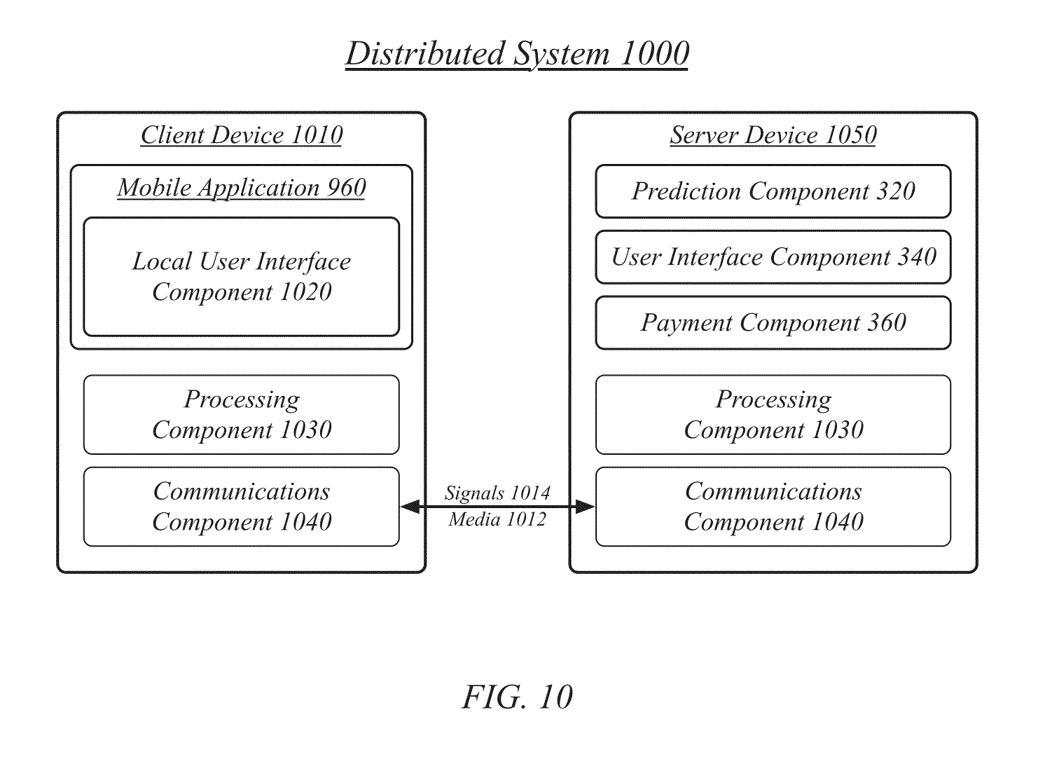

FIG. 10 illustrates a block diagram of a distributed system 1000. The distributed system 1000 may distribute portions of the structure and/or operations for the peer-to-peer payment system 100 across multiple computing entities. Examples of distributed system 1000 may include without limitation a client-server architecture, a S-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 1000 may comprise a client device 1010 and a server device 1050. In general, the client device 1010 and the server device 1050 may be the same or similar to the client device 820 as described with reference to FIG. 8. For instance, the client system 1010 and the server system 1050 may each comprise a processing component 1030 and a communications component 1040 which are the same or similar to the processing component 830 and the communications component 840, respectively, as described with reference to FIG. 8. In another example, the devices 1010, 1050 may communicate over a communications media 1012 using communications signals 1014 via the communications components 1040.

The server device 1050 may comprise or employ one or more server programs that operate to perform various methodologies in accordance with the described embodiments. In one embodiment, for example, the server device 1050 may implement the prediction component 320, the user interface component 340, and the payment component 360.

The client device 1010 may comprise or employ one or more client programs that operate to perform various methodologies in accordance with the described embodiments. In one embodiment, for example, the client device 1010 may implement a mobile application 960 having a local user interface component 1020 acting as a local interface for the user interface component 340 and payment component 360 of the peer-to-peer payment system 100. The signals 1014 transmitted over media 1012 may comprise the coordination of the local user interface component 1020, user interface component 340, and payment component 360.

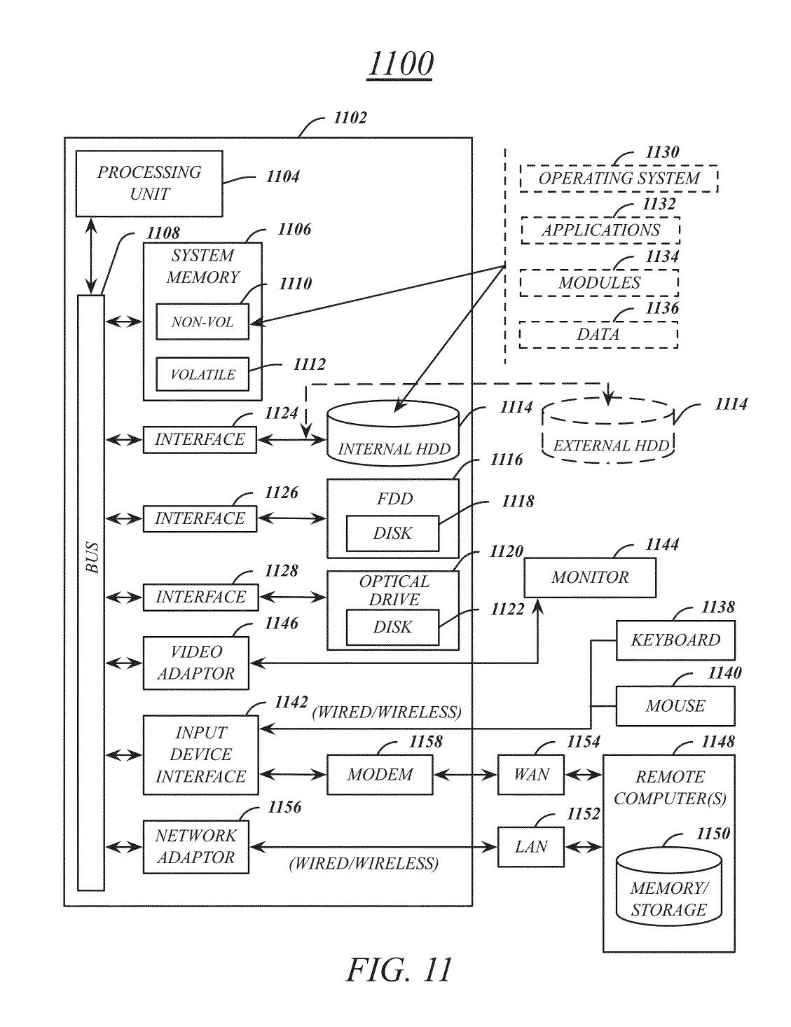

FIG. 11 illustrates an embodiment of an exemplary computing architecture 1100 suitable for implementing various embodiments as previously described. In one embodiment, the computing architecture 1100 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1100.

As shown in FIG. 11, the computing architecture 1100 comprises a processing unit 1104, a system memory 1106 and a system bus 1108. The processing unit 1104 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1104.

The system bus 1108 provides an interface for system components including, but not limited to, the system memory 1106 to the processing unit 1104. The system bus 1108 can be any of several types of bus structure that may further interconnect to a memory bus (with or without a memory controller), a peripheral bus, and a local bus using any of a variety of commercially available bus architectures. Interface adapters may connect to the system bus 1108 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1100 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1106 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 11, the system memory 1106 can include non-volatile memory 1110 and/or volatile memory 1112. A basic input/output system (BIOS) can be stored in the non-volatile memory 1110.

The computer 1102 may include various types of computer-readable storage media in the form of one or more lower speed memory units, including an internal (or external) hard disk drive (HDD) 1114, a magnetic floppy disk drive (FDD) 1116 to read from or write to a removable magnetic disk 1118, and an optical disk drive 1120 to read from or write to a removable optical disk 1122 (e.g., a CD-ROM or DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1110, 1112, including an operating system 1130, one or more application programs 1132, other program modules 1134, and program data 1136. In one embodiment, the one or more application programs 1132, other program modules 1134, and program data 1136 can include, for example, the various applications and/or components of the peer-to-peer payment system 100.

A user can enter commands and information into the computer 1102 through one or more wire/wireless input devices, for example, a keyboard 1138 and a pointing device, such as a mouse 1140. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, and so forth.

A monitor 1144 or other type of display device is also connected to the system bus 1108 via an interface, such as a video adaptor 1146. The monitor 1144 may be internal or external to the computer 1102. In addition to the monitor 1144, a computer typically includes other peripheral output devices, such as speakers, printers, and so forth.

The computer 1102 may operate in a networked environment using logical connections via wire and/or wireless communications to one or more remote computers, such as a remote computer 1148. The remote computer 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, connects to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

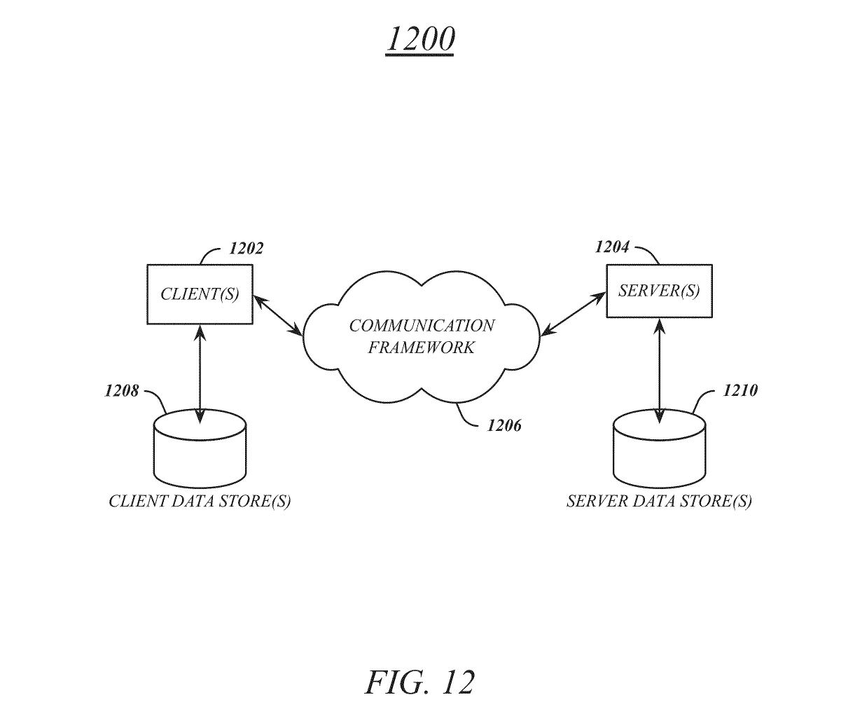

FIG. 12 illustrates a block diagram of an exemplary communications architecture 1200 suitable for implementing various embodiments as previously described. The communications architecture 1200 includes various common communications elements, such as a transmitter, receiver, transceiver, radio, network interface, baseband processor, antenna, amplifiers, filters, power supplies, and so forth. The embodiments, however, are not limited to implementation by the communications architecture 1200.

As shown in FIG. 12, the communications architecture 1200 comprises includes one or more clients 1202 and servers 1204. The clients 1202 may implement the client device 910. The servers 1204 may implement the server device 950. The clients 1202 and the servers 1204 are operatively connected to one or more respective client data stores 1208 and server data stores 1210 that can be employed to store information local to the respective clients 1202 and servers 1204, such as cookies and/or associated contextual information.

The clients 1202 and the servers 1204 may communicate information between each other using a communication framework 1206. The communications framework 1206 may implement any well-known communications techniques and protocols. The communications framework 1206 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1206 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1202 and the servers 1204. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

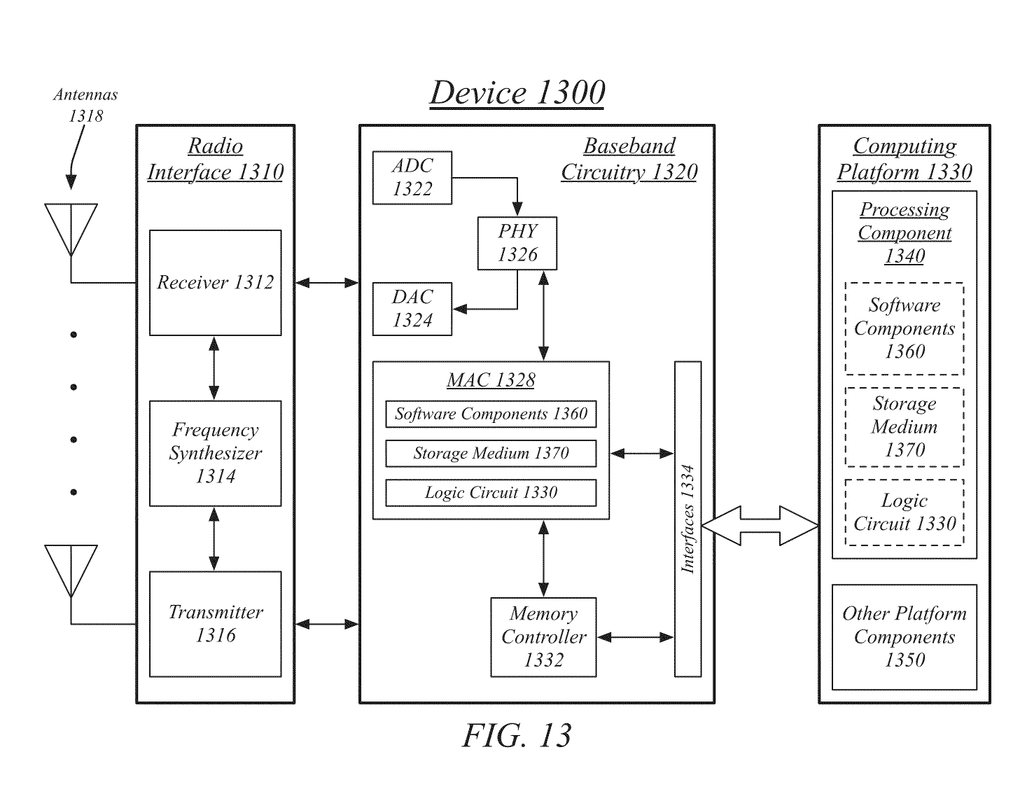

FIG. 13 illustrates an embodiment of a device 1300 for use in a multicarrier OFDM system, such as the peer-to-peer payment system 100. Device 1300 may implement, for example, software components 1360 as described with reference to peer-to-peer payment system 100 and/or a logic circuit 1330. The logic circuit 1330 may include physical circuits to perform operations described for the peer-to-peer payment system 100. As shown in FIG. 13, device 1300 may include a radio interface 1310, baseband circuitry 1320, and computing platform 1330, although embodiments are not limited to this configuration.

The device 1300 may implement some or all of the structure and/or operations for the peer-to-peer payment system 100 and/or logic circuit 1330 in a single computing entity, such as entirely within a single device. Alternatively, the device 1300 may distribute portions of the structure and/or operations for the peer-to-peer payment system 100 and/or logic circuit 1330 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1310 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 1310 may include, for example, a receiver 1312, a transmitter 1316 and/or a frequency synthesizer 1314. Radio interface 1310 may include bias controls, a crystal oscillator and/or one or more antennas 1318. In another embodiment, radio interface 1310 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1320 may communicate with radio interface 1310 to process receive and/or transmit signals and may include, for example, an analog-to-digital converter 1322 for down converting received signals, a digital-to-analog converter 1324 for up converting signals for transmission. Further, baseband circuitry 1320 may include a baseband or physical layer (PHY) processing circuit 1356 for PHY link layer processing of respective receive/transmit signals. Baseband circuitry 1320 may include, for example, a processing circuit 1328 for medium access control (MAC)/data link layer processing. Baseband circuitry 1320 may include a memory controller 1332 for communicating with processing circuit 1328 and/or a computing platform 1330, for example, via one or more interfaces 1334.

In some embodiments, PHY processing circuit 1326 may include a frame construction and/or detection module, in combination with additional circuitry such as a buffer memory, to construct and/or deconstruct communication frames, such as radio frames. Alternatively or in addition, MAC processing circuit 1328 may share processing for certain of these functions or perform these processes independent of PHY processing circuit 1326. In some embodiments, MAC and PHY processing may be integrated into a single circuit.

The computing platform 1330 may provide computing functionality for the device 1300. As shown, the computing platform 1330 may include a processing component 1340. In addition to, or alternatively of, the baseband circuitry 1320, the device 1300 may execute processing operations or logic for the peer-to-peer payment system 100 and logic circuit 1330 using the processing component 1340. The processing component 1340 (and/or PHY 1326 and/or MAC 1328) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1330 may further include other platform components 1350. Other platform components 1350 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1300 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 1300 described herein, may be included or omitted in various embodiments of device 1300, as suitably desired. In some embodiments, device 1300 may be configured to be compatible with protocols and frequencies associated one or more of the 3GPP LTE Specifications and/or IEEE 1302.16 Standards for WMANs, and/or other broadband wireless networks, cited herein, although the embodiments are not limited in this respect.

Embodiments of device 1300 may be implemented using single input single output (SISO) architectures. However, certain implementations may include multiple antennas (e.g., antennas 1318) for transmission and/or reception using adaptive antenna techniques for beamforming or spatial division multiple access (SDMA) and/or using MIMO communication techniques.

The components and features of device 1300 may be implemented using any combination of discrete circuitry, application specific integrated circuits (ASICs), logic gates and/or single chip architectures. Further, the features of device 1300 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1300 shown in the block diagram of FIG. 13 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

A computer-implemented method may comprise receiving context information for a user; predicting a user interest in a payment transaction based on the context information; offering to initiate the payment transaction to the user based on the predicted user interest in the payment transaction; receiving a user confirmation of the user interest in the payment transaction; and initiating the payment transaction in response to the received user confirmation.

A computer-implemented method may comprise the user registered with a social-networking service, the context information comprising at least social-networking information for the user on the social-networking service.

A computer-implemented method may comprise the context information comprising at least a text conversation between the user and a second user, the predicted payment transaction comprising a payment from at least one of the user to the second user and the second user to the user, wherein initiating the payment transaction comprises transmitting a payment request to the second user.

A computer-implemented method may comprise performing a natural language processing of the text conversation to determine a natural language text sequence associated with payment by at least one of the user and the second user, wherein predicting the user interest in the payment transaction is in response to the determination of the association between the natural language text sequence and payment.

A computer-implemented method may comprise determining a confidence level for the determined association between the natural language text sequence and payment and selecting a notification channel from a plurality of notification channels based on the confidence level.

A computer-implemented method may comprise notifying the user and the second user of the payment transaction by inserting a text message in the text conversation between the user and the second user, the text message identified as originating from a payment-specific avatar.

A computer-implemented method may comprise displaying the text conversation to the user in a messaging interface; displaying a payment transaction notification in association with the text conversation in the messaging interface; receiving a user selection to view the payment transaction notification; and displaying an offer to initiate the payment transaction to the user in the messaging interface in response to the received user selection.

A computer-implemented method may comprise the context information comprising a current user location for the user, the payment transaction associated with a location-based service, further comprising: determining a service provider and a request configuration for the service provider, wherein at least one of the determination of the service provider and the determination of the request configuration is based on the current user location for the mobile device; and transmitting a service request to the service provider in response to the received user confirmation of the user interest in the payment transaction, the service request comprising the request configuration

A computer-implemented method may comprise the location-based service comprising one of a transportation service, a food or drink service, and an entertainment service.

A computer-implemented method may comprise the context information comprising event information for an event in a calendar for the user, the payment transaction associated with participation in the event by the user.

A computer-implemented method may comprise the context information comprising a location history for the user, further comprising: determining that the location history indicates that the user attended the event; and predicting the user interest in the payment transaction based at least in part on the indication that the user attended the event.

A computer-implemented method may comprise the user registered with a social-networking service, the context information comprising personal relationship information, further comprising: predicting one or more friends of the user in the social-networking service potentially associated with the payment transaction based on the personal relationship information; and recommending the one or more friends for inclusion in the payment transaction in response to the prediction.

A computer-implemented method may comprise the user registered with a social-networking service, the payment transaction associated with a service provider, further comprising: determining a social graph relationship between the user and a second user, the second user registered with the social-networking service; and displaying a recommendation to share a service provided by the service provider with the second user to the user, the recommendation displayed to the user in association with notification of the determined social graph relationship.

A computer-implemented method may comprise wherein the recommendation comprises a reputation score for the second user.

A computer-implemented method may comprise determining that the user is registered with the service provider; determining that a second user is not registered with the service provider; and offering use of a service provided by the service provider to the second user by sharing use of the service with the user.

A computer-implemented method may comprise the payment transaction associated with a service provider, the context information comprising a determination of physical proximity to one or more suggested users, further comprising: suggesting the one or more suggested users for splitting payment of the payment transaction to the user; receiving a user selection of one or more selected users of the one or more suggested users; and transmitting a payment request to the one or more selected users.

A computer-implemented method may comprise performing a previous payment transaction for the user, the previous payment transaction associated with previous context information; determining a correspondence between the context information and the previous context information; and predicting the user interest in the payment transaction based on the correspondence between the context information and the previous context information.

A computer-implemented method may comprise the user registered with a social-networking service, the payment transaction for payment by the user to a second user registered with the social-networking service, further comprising: inserting a payment reminder for the payment transaction into a news feed of the social-networking service for the user.

A computer-implemented method may comprise the user registered with a social-networking service, the payment transaction for payment by a second user of the social-networking service, further comprising: inserting a payment completion notification for the payment transaction into a news feed of the social-networking service for the user.

A computer-implemented method may comprise the user registered with a social-networking service, the payment transaction for a collective payment by a group of users, further comprising: inserting a payment progress notification for the payment transaction into a news feed of the social-networking service for at least one user of the group of users.

A computer-implemented method may comprise the user registered with a social-networking service, the payment transaction for a collective payment by a group of users, further comprising: determining a delinquent user of the group of users based on the delinquent user having not performed a portion of the collective payment assigned to the delinquent user; and inserting a payment reminder for the payment transaction into a news feed of the social-networking service for the delinquent user, the payment reminder comprising a notification of group participation in the payment transaction.

A computer-implemented method may comprise the notification of group participation indicating that other users of the group of users are also recipients of the notification of group participation.

A computer-implemented method may comprise the payment transaction between at least between the user and a second user, the user registered with a social-networking service, the second user registered with the social-networking service, further comprising: determining a third user of the social-networking service based on relationship information for the user and the second user; and recommending the third user as a mediator of the payment transaction to the user and the second user.

A computer-implemented method may comprise the payment transaction between at least between the user and a second user, the user registered with a social-networking service, the second user registered with the social-networking service, the second user associated with identity information for the second user in the social-networking service, further comprising: displaying a realness score for the second user to the user, the realness score representing a confidence in the accuracy of the identity information for the second user in the social-networking service.

A computer-implemented method may comprise receiving image content; determining that the image content corresponds to a bill; determining a payment amount for the payment transaction based on the bill; determining bill context information for the bill; determining one or more suggested users based on association between the context information and the bill context information; suggesting the one or more suggested users for splitting the payment amount for the payment transaction to the user; and initiating the payment transaction by transmitting a payment request to the one or more suggested users.

A computer-implemented method may comprise the context information comprising a current user location and a user activity history, further comprising: determining a service provider in proximity to the current user location and providing a service represented in the user activity history, wherein the predicted user interest comprises reception of the service by the user from the service provider, wherein offering to initiate the payment transaction comprises recommending the service provider to the user.

A computer-implemented method may comprise determining a time of day associated with the service represented in the user activity history; and recommending the service provider to the user in response to a determination that the user is unscheduled at the time of day in a current day in a calendar for the user.

A computer-implemented method may comprise the user registered with a social-networking service, a second user registered with the social-networking service, the context information indicating a personal association between the user and the second user in the social-networking service, further comprising: determining that social-networking information for the second user indicates an upcoming gift-giving occasion for the second user, the payment transaction comprising a gift giving, wherein predicting the user interest in the payment transaction is based on the indication of the upcoming gift-giving occasion for the second user and the indication of the personal association between the user and the second user.

An example apparatus may comprise a processor circuit on a device, a prediction component operative on the processor circuit to receive context information for a user and predict a user interest in a payment transaction based on the context information; a user interface component operative to offer to initiate the payment transaction to the user based on the predicted user interest in the payment transaction and receive a user confirmation of the user interest in the payment transaction; and a payment component operative to initiate the payment transaction in response to the received user confirmation. The apparatus may be operative to implement any of the computer-implemented methods described herein.

At least one computer-readable storage medium may comprise instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
receiving context information for a user;
predicting a user interest in a payment transaction based on the context information;
offering to initiate the payment transaction to the user based on the predicted user interest in the payment transaction;
receiving a user confirmation of the user interest in the payment transaction; and
initiating the payment transaction in response to the received user confirmation.

2. The method of claim 1, the user registered with a social-networking service, the context information comprising at least social-networking information for the user on the social-networking service.

3. The method of claim 2, the user registered with a social-networking service, the payment transaction associated with a service provider, further comprising:
determining a social graph relationship between the user and a second user based on the social-networking information, the second user registered with the social-networking service; and
displaying a recommendation to share a service provided by the service provider with the second user to the user, the recommendation displayed to the user in association with notification of the determined social graph relationship, the recommendation comprising a reputation score for the second user.

4. The method of claim 2, the payment transaction between at least between the user and a second user, the second user registered with the social-networking service, the social-networking information comprising relationship information for the user and the second user, further comprising:
determining a third user of the social-networking service based on the relationship information for the user and the second user; and
recommending the third user as a mediator of the payment transaction to the user and the second user.

5. The method of claim 1, the context information comprising at least a text conversation between the user and a second user, the predicted payment transaction comprising a payment from at least one of the user to the second user and the second user to the user, wherein initiating the payment transaction comprises transmitting a payment request to the second user.

6. The method of claim 5, further comprising:
performing a natural language processing of the text conversation to determine a natural language text sequence associated with payment by at least one of the user and the second user, wherein predicting the user interest in the payment transaction is in response to the determination of the association between the natural language text sequence and payment;
determining a confidence level for the determined association between the natural language text sequence and payment; and
selecting a notification channel from a plurality of notification channels based on the confidence level.

7. The method of claim 1, the context information comprising a current user location for the user, the payment transaction associated with a location-based service.

8. The method of claim 7, further comprising:
determining a service provider and a request configuration for the service provider, wherein at least one of the determination of the service provider and the determination of the request configuration is based on the current user location for the mobile device; and
transmitting a service request to the service provider in response to the received user confirmation of the user interest in the payment transaction, the service request comprising the request configuration.

9. The method of claim 1, the context information comprising event information for an event in a calendar for the user, the payment transaction associated with participation in the event by the user.

10. The method of claim 9, the context information comprising a location history for the user, further comprising:
determining that the location history indicates that the user attended the event; and
predicting the user interest in the payment transaction based at least in part on the indication that the user attended the event.

11. An apparatus, comprising:
a processor circuit on a device;
a prediction component operative on the processor circuit to receive context information for a user and predict a user interest in a payment transaction based on the context information;
a user interface component operative to offer to initiate the payment transaction to the user based on the predicted user interest in the payment transaction and receive a user confirmation of the user interest in the payment transaction; and
a payment component operative to initiate the payment transaction in response to the received user confirmation.

12. The apparatus of claim 11, the user registered with a social-networking service, the context information comprising at least social-networking information for the user on the social-networking service, further comprising:
the prediction component operative to determine a social graph relationship between the user and a second user based on the social-networking information, the second user registered with the social-networking service;
the user interface component operative to display a recommendation to share a service provided by the service provider with the second user to the user, the recommendation displayed to the user in association with notification of the determined social graph relationship, the recommendation comprising a reputation score for the second user.

13. The apparatus of claim 11, the context information comprising at least a text conversation between the user and a second user, the predicted payment transaction comprising a payment from at least one of the user to the second user and the second user to the user, wherein initiating the payment transaction comprises transmitting a payment request to the second user, further comprising:
a natural language processor operative to perform a natural language processing of the text conversation to determine a natural language text sequence associated with payment by at least one of the user and the second user, wherein predicting the user interest in the payment transaction is in response to the determination of the association between the natural language text sequence and payment;
the prediction component operative to determine a confidence level for the determined association between the natural language text sequence and payment; and
the user interface component operative to select a notification channel from a plurality of notification channels based on the confidence level.

14. The apparatus of claim 11, the context information comprising a current user location for the user, the payment transaction associated with a location-based service, further comprising:
the prediction component operative to determine determining a service provider and a request configuration for the service provider, wherein at least one of the determination of the service provider and the determination of the request configuration is based on the current user location for the mobile device; and
the payment component operative to transmit a service request to the service provider in response to the received user confirmation of the user interest in the payment transaction, the service request comprising the request configuration.

15. The apparatus of claim 11, the context information comprising event information for an event in a calendar for the user, the payment transaction associated with participation in the event by the user, further comprising:
the prediction component operative to determine that the location history indicates that the user attended the event and predict the user interest in the payment transaction based at least in part on the indication that the user attended the event.

16. At least one computer-readable storage medium comprising instructions that, when executed, cause a system to:
receive context information for a user;
predict a user interest in a payment transaction based on the context information;
offer to initiate the payment transaction to the user based on the predicted user interest in the payment transaction;
receive a user confirmation of the user interest in the payment transaction; and
initiate the payment transaction in response to the received user confirmation.

17. The computer-readable storage medium of claim 16, the user registered with a social-networking service, the context information comprising at least social-networking information for the user on the social-networking service, the payment transaction between at least between the user and a second user, the second user registered with the social-networking service, the social-networking information comprising relationship information for the user and the second user, comprising further instructions that, when executed, cause a system to:
determine a third user of the social-networking service based on the relationship information for the user and the second user; and
recommend the third user as a mediator of the payment transaction to the user and the second user

18. The computer-readable storage medium of claim 16, the context information comprising at least a text conversation between the user and a second user, the predicted payment transaction comprising a payment from at least one of the user to the second user and the second user to the user, wherein initiating the payment transaction comprises transmitting a payment request to the second user, comprising further instructions that, when executed, cause a system to:
perform a natural language processing of the text conversation to determine a natural language text sequence associated with payment by at least one of the user and the second user, wherein predicting the user interest in the payment transaction is in response to the determination of the association between the natural language text sequence and payment;
determine a confidence level for the determined association between the natural language text sequence and payment; and
select a notification channel from a plurality of notification channels based on the confidence level.

19. The computer-readable storage medium of claim 16, the context information comprising a current user location for the user, the payment transaction associated with a location-based service, comprising further instructions that, when executed, cause a system to:
determine a service provider and a request configuration for the service provider, wherein at least one of the determination of the service provider and the determination of the request configuration is based on the current user location for the mobile device; and
transmit a service request to the service provider in response to the received user confirmation of the user interest in the payment transaction, the service request comprising the request configuration.

20. The computer-readable storage medium of claim 16, the context information comprising event information for an event in a calendar for the user, the payment transaction associated with participation in the event by the user, the context information comprising a location history for the user, comprising further instructions that, when executed, cause a system to:
determine that the location history indicates that the user attended the event; and
predict the user interest in the payment transaction based at least in part on the indication that the user attended the event.
